(19) United States
(12) Patent Application Publication
(10) Pub. No.: US 2011/0319305 A1
(43) Pub. Date: Dec. 29, 2011

(54) USE OF COMB COPOLYMERS FOR IMPROVING SCUFFING LOAD CAPACITY

(75) Inventors: Boris Eisenberg, Happenheim (DE); Roland Schweder, Darmstadt (DE); Michael Alibert, Darmstadt (DE); Torsten Stoehr, Frankfurt (DE)

(73) Assignee: EVONIK ROHMAX ADDITIVES GMBH, Darmstadt (DE)

(21) Appl. No.: 13/255,218

(22) PCT Filed: Feb. 9, 2010
(86) PCT No.: PCT/EP2010/051564

§ 371 Date: Sep. 7, 2011

(30) Foreign Application Priority Data
Mar. 10, 2009 (DE) 10 2009 001 447.0

(51) Int. Cl. C10M 169/04; C08F 236/22

(52) U.S. Cl. 508/463; 526/329.1

(57) ABSTRACT

The present invention relates to the use of comb polymers comprising, in the main chain, repeat units derived from polyolefin-based macromonomers with a molecular weight of at least 500 g/mol, and repeat units derived from low molecular weight monomers with a molecular weight less than 500 g/mol, for improving the load-bearing capacity of hydraulic fluids. Furthermore, the present invention describes new hydraulic fluids.

The present invention relates to the use of comb polymers for improving load-bearing capacity. The present invention further describes hydraulic fluids with improved properties, more particularly outstanding energy efficiency and excellent load-bearing capacity.

Hydraulic oils are typically classified into ISO classes, e.g. ISO VG 46, the class specified being equivalent to the kinematic viscosity at 40° C. (ISO 46=>KV40=46 mm²/s; ISO 32=>KV40=32 mm²/s). A multigrade oil with higher viscosity index can be obtained if, instead of a mineral oil of the desired ISO class, a lower-viscosity oil is taken and the desired KV40 is established with the aid of a VI improver. The lower the base oil viscosity, the higher the KV100 for a given KV40, i.e. the higher is the viscosity index and the amount of VI improver required for that purpose. The VI improvers used here are typically polyalkyl methacrylates, styrene-maleate copolymers, olefin copolymers (so-called OCPs) and polyisobutenes.

One way of improving the volumetric efficiency of hydraulic pumps is to use shear-stable multigrade oils with high viscosity index. Such an oil is notable for relatively low viscosities at low temperatures and as a result for a relatively high mechanical efficiency. The leakage flow in the pump is negligibly low for both oils within this high viscosity range. At relatively high temperature, i.e. within the typical operating range of approx. 80-90° C., a multigrade oil with high VI exhibits a much higher viscosity than a single-grade oil. The higher viscosity reduces the leakage flow in the pump. The volumetric efficiency of the pump is higher as a result, and the mechanical efficiency is only negligibly lower.

For example, patent application WO 2005/108531 describes hydraulic oils comprising polyalkyl (meth)acrylates. The addition of these additives allows a reduction in the temperature rise in the course of operation of hydraulic systems to be achieved.

However, the result of lowering the base oil viscosity is a fall in the load-bearing capacity, also called scuffing load capacity. The load-bearing capacity of an oil is determined, for example, with the gear rig test machine from FZG (Institute for Machine Elements—Gear Research Center of the Technical University of Munich) to DIN 51354-2 or DIN ISO 14635-1. What is reported is the load-bearing capacity, i.e. the load stage, which was the first in the test to lead to damage to the gears, e.g. LS10 (load stage 10→373 Nm). The scuffing load capacity can be distinctly improved by addition of antiwear additives or EP (extreme pressure) additives. Although these additives could compensate for the reduction in the load-bearing capacity associated with a lowering of the base oil viscosity, this would be associated with higher costs and other disadvantages, such that oils with a low base oil viscosity typically exhibit relatively poor load-bearing capacity. It should be emphasized here that the addition of antiwear additives can only increase the load-bearing capacity to a limited degree.

Due to a general scarcity of raw materials, there is rising interest in techniques for saving energy. As already detailed above, this also includes, in the field of hydraulic systems, the rise in efficiency achievable in the case of use of particular hydraulic oils. On the other hand, these measures should not lead to damage to the hydraulic systems.

However, it has only been possible to date to achieve a high load stage by the use of oils with a relatively high viscosity or by use of specific materials for gearing and/or roller bearings. However, both options are afflicted by disadvantages, the use of new materials being expensive and a further improvement being desirable. The use of high-viscosity oils leads to high internal friction and hence to high fuel consumption. Therefore, compounds which can be used to improve the load-bearing capacity would be especially helpful. These additives should, especially also in the case of relatively low-viscosity base oils, lead to a perceptible improvement which cannot be achieved by means of large amounts of conventional additives, with simultaneously low expenditure and without any disadvantages in the event of overdosage.

In view of the prior art, it was thus an object of the present invention to provide an additive which leads to an improvement in the load-bearing capacity of hydraulic oils (antiscuffing). This improvement should be achieved especially in the case of hydraulic oils which have a low viscosity of the base oil.

In addition, it was therefore an object of the present invention to provide an additive which either leads to a reduction in the fuel consumption of hydraulic systems or whose use can achieve a distinct rise in efficiency (i.e. higher productivity).

Accordingly, a hydraulic oil was to be provided which, with a given load-bearing capacity in hydraulic systems, leads to a surprisingly low energy consumption. Secondly, it was an object of the present invention, for a given energy consumption of a hydraulic system, to provide a hydraulic fluid which exhibits a particularly high load-bearing capacity.

It was a further object of the invention to provide additives which can be produced in a simple and inexpensive manner, and commercially available components in particular should be used. In this context, production should proceed on the industrial scale without any need for new plants or plants of complex construction.

It was a further aim of the present invention to provide an additive which brings about a multitude of desirable properties in the hydraulic fluid. This can minimize the number of different additives.

In addition, the additive should not exhibit any adverse effects on the environmental compatibility of the hydraulic oil.

Furthermore, the additives should exhibit a particularly long service life and low degradation during use, such that correspondingly modified hydraulic oils can be used over a long period.

These objects, and further objects which are not stated explicitly but which are immediately derivable or discernible from the connections discussed herein by way of introduction, are achieved by the use of comb polymers having all the features of claim 1. A particularly advantageous solution is offered by the hydraulic fluid detailed in claim 4. Appropriate modifications of the inventive hydraulic fluid are protected in the dependent claims referring back to claim 4.

The present invention accordingly provides for the use of comb polymers comprising, in the main chain, repeat units derived from polyolefin-based macromonomers with a molecular weight of at least 500 g/mol, and repeat units derived from low molecular weight monomers with a molecular weight less than 500 g/mol, for improving the load-bearing capacity of hydraulic fluids.

Particular advantages can surprisingly be achieved by particular hydraulic fluids which are provided by the present invention. The present invention accordingly further provides a hydraulic fluid comprising at least one lubricant oil and at least one polymer, characterized in that the polymer is a comb polymer comprising, in the main chain, repeat units derived from polyolefin-based macromonomers with a molecular weight of at least 500 g/mol, and repeat units derived from low molecular weight monomers with a molecular weight less than 500 g/mol, and the hydraulic fluid has a demulsification value of less than 30 minutes.

It is thus possible in an unforeseeable manner to provide an additive for lubricant oils, which leads to an improvement in the load-bearing capacity of hydraulic fluids (antiscuffing). This improvement can be achieved especially in the case of hydraulic oils having a low viscosity of the base oil.

Above this, the present invention provides an additive which leads to a reduction in the fuel consumption of hydraulic systems.

Accordingly, it is possible through the present invention to provide a hydraulic oil which, for a given load-bearing capacity in hydraulic systems, leads to a surprisingly low energy consumption. Secondly, for a given energy consumption of a hydraulic system, it is possible to provide a hydraulic fluid which exhibits a particularly high load-bearing capacity.

In addition, it is possible to provide these additives in a simple and inexpensive manner, and commercially available components in particular can be used. The production here can be effected on the industrial scale without any need for new plants or plants of complex design for this purpose.

Furthermore, the polymers for use in accordance with the invention exhibit a particularly favorable profile of properties. For instance, the polymers can be configured with surprising shear stability, such that the hydraulic oils have a very long service life. In addition, the additive for use in accordance with the invention can bring about a multitude of desirable properties in the lubricant. For example, hydraulic oils can be produced with outstanding low-temperature properties or viscosity properties. This allows the number of different additives to be minimized. Moreover, the comb polymers for use in the present case are compatible with many additives. This allows the hydraulic oils to be matched to a wide variety of different requirements.

Furthermore, the additives to be used do not exhibit any adverse effects on the environmental compatibility of the hydraulic oil.

The term “comb polymer” used herein is known per se, meaning that relatively long side chains are bonded to a polymeric main chain, frequently also known as the backbone. In the present case, the inventive polymers have at least one repeat unit derived from polyolefin-based macromonomers.

The term “main chain” does not necessarily mean that the chain length of the main chain is greater than that of the side chains. Instead, this term relates to the composition of this chain. While the side chain has very high proportions of olefinic repeat units, especially units derived from alkenes or alkadienes, for example ethylene, propylene, n-butene, isobutene, butadiene, isoprene, the main chain is derived from major proportions of more polar unsaturated monomers including other alkyl (meth)acrylates, styrene monomers, fumarates, maleates, vinyl esters and/or vinyl ethers.

The term “repeat unit” is widely known in the technical field. The present comb polymers can preferably be obtained by means of free-radical polymerization of macromonomers and low molecular weight monomers. In this reaction, double bonds are opened up to form covalent bonds. Accordingly, the repeat unit arises from the monomers used. However, the present comb polymers can also be obtained by polymer-analogous reactions and/or graft copolymerization. In this case, the converted repeat unit of the main chain is counted as the repeat unit derived from a polyolefin-based macromonomer. The same applies in the case of preparation of the inventive comb polymers by graft copolymerization.

The present invention describes comb polymers which preferably have a high oil solubility. The term “oil-soluble” means that a mixture of a base oil and an inventive comb polymer which has at least 0.1% by weight, preferably at least 0.5% by weight, of the inventive comb polymers is preparable without macroscopic phase formation. The comb polymer can be present in dispersed and/or dissolved form in this mixture. The oil solubility depends in particular on the proportion of lipophilic side chains and on the base oil. This property is known to those skilled in the art and can be adjusted for the particular base oil easily via the proportion of lipophilic monomers.

The inventive comb polymers comprise repeat units derived from polyolefin-based macromonomers. Polyolefin-based macromonomers are known in the technical field. These repeat units comprise at least one group derived from polyolefins. Polyolefins are known in the technical field, and can be obtained by polymerizing alkenes and/or alkadienes which consist of the elements carbon and hydrogen, for example C2-C10-alkenes such as ethylene, propylene, n-butene, isobutene, norbornene, and/or C4-C10-alkadienes such as butadiene, isoprene, norbornadiene. The repeat units derived from polyolefin-based macromonomers comprise preferably at least 70% by weight and more preferably at least 80% by weight and most preferably at least 90% by weight of groups derived from alkenes and/or alkadienes, based on the weight of the repeat units derived from polyolefin-based macromonomers. The polyolefinic groups may in particular also be present in hydrogenated form. In addition to the groups derived from alkenes and/or alkadienes, the repeat units derived from polyolefin-based macromonomers may comprise further groups. These include small proportions of copolymerizable monomers. These monomers are known per se and include, among other monomers, alkyl (meth)acrylates, styrene monomers, fumarates, maleates, vinyl esters and/or vinyl ethers. The proportion of these groups based on copolymerizable monomers is preferably at most 30% by weight, more preferably at most 15% by weight, based on the weight of the repeat units derived from polyolefin-based macromonomers. In addition, the repeat units derived from polyolefin-based macromonomers may comprise start groups and/or end groups which serve for functionalization or are caused by the preparation of the repeat units derived from polyolefin-based macromonomers. The proportion of these start groups and/or end groups is preferably at most 30% by weight, more preferably at most 15% by weight, based on the weight of the repeat units derived from polyolefin-based macromonomers.

The number-average molecular weight of the repeat units derived from polyolefin-based macromonomers is preferably in the range from 500 to 50 000 g/mol, more preferably 700 to 10 000 g/mol, especially 1500 to 5500 g/mol and most preferably 4000 to 5000 g/mol.

In the case of preparation of the comb polymers by copolymerization of low molecular weight and macromolecular monomers, these values arise through the properties of the macromolecular monomers. In the case of polymer-analogous reactions, this property arises, for example, from the macroalcohols and/or macroamines used, taking account of the converted repeat units of the main chain. In the case of graft copolymerizations, the proportion of polyolefins formed which have not been incorporated into the main chain can be used to conclude the molecular weight distribution of the polyolefin.

The repeat units derived from polyolefin-based macromonomers preferably have a low melting point, which is measured by means of DSC. The melting point of the repeat units derived from the polyolefin-based macromonomers is preferably less than or equal to −10° C., especially preferably less than or equal to −20° C., more preferably less than or equal to −40° C. Most preferably, no DSC melting point can be measured for the repeat units derived from the polyolefin-based macromonomers.

In addition to the repeat units derived from the polyolefin-based macromonomers, the inventive comb polymers comprise repeat units derived from low molecular weight monomers with a molecular weight less than 500 g/mol. The expression “low molecular weight” makes it clear that some of the repeat units of the backbone of the comb polymer have a low molecular weight. Depending on the preparation, this molecular weight may result from the molecular weight of the monomers used to prepare the polymers. The molecular weight of the low molecular weight repeat units or of the low molecular weight monomers is preferably at most 400 g/mol, more preferably at most 200 g/mol and most preferably at most 150 g/mol. These monomers include alkyl (meth)acrylates, styrene monomers, fumarates, maleates, vinyl esters and/or vinyl ethers.

The preferred low molecular weight monomers include styrene monomers having 8 to 17 carbon atoms, alkyl (meth)acrylates having 1 to 10 carbon atoms in the alcohol group, vinyl esters having 1 to 11 carbon atoms in the acyl group, vinyl ethers having 1 to 10 carbon atoms in the alcohol group, (di)alkyl fumarates having 1 to 10 carbon atoms in the alcohol group, (di)alkyl maleates having 1 to 10 carbon atoms in the alcohol group, and mixtures of these monomers derived are. These monomers are widely known in the technical field.

Examples of styrene monomers having 8 to 17 carbon atoms are styrene, substituted styrenes having an alkyl substituent in the side chain, for example α-methylstyrene and α-ethylstyrene, substituted styrenes having an alkyl substituent on the ring, such as vinyltoluene and p-methylstyrene, halogenated styrenes, for example monochlorostyrenes, dichlorostyrenes, tribromostyrenes and tetrabromostyrenes.

The expression “(meth)acrylates” encompasses acrylates and methacrylates, and also mixtures of acrylates and methacrylates. The alkyl (meth)acrylates having 1 to 10 carbon atoms in the alcohol group include especially (meth)acrylates which derive from saturated alcohols, such as methyl (meth)acrylate, ethyl (meth)acrylate, n-propyl (meth)acrylate, isopropyl (meth)acrylate, n-butyl (meth)acrylate, tert-butyl (meth)acrylate, pentyl (meth)acrylate, hexyl (meth)acrylate, 2-ethylhexyl (meth)acrylate, heptyl (meth)acrylate, 2-tert-butylheptyl (meth)acrylate, octyl (meth)acrylate, 3-isopropylheptyl (meth)acrylate, nonyl (meth)acrylate, decyl (meth)acrylate; (meth)acrylates which derive from unsaturated alcohols, for example 2-propynyl (meth)acrylate, allyl (meth)acrylate, vinyl (meth)acrylate, oleyl (meth)acrylate; cycloalkyl (meth)acrylates such as cyclopentyl (meth)acrylate, 3-vinylcyclohexyl (meth)acrylate.

Preferred alkyl (meth)acrylates include 1 to 8, more preferably 1 to 4 carbon atoms in the alcohol group. The alcohol group here may be linear or branched.

Examples of vinyl esters having 1 to 11 carbon atoms in the acyl group include vinyl formate, vinyl acetate, vinyl propionate, vinyl butyrate. Preferred vinyl esters include 2 to 9, more preferably 2 to 5 carbon atoms in the acyl group. The acyl group here may be linear or branched.

Examples of vinyl ethers having 1 to 10 carbon atoms in the alcohol group include vinyl methyl ether, vinyl ethyl ether, vinyl propyl ether, vinyl butyl ether. Preferred vinyl ethers include 1 to 8, more preferably 1 to 4 carbon atoms in the alcohol group. The alcohol group here may be linear or branched.

The notation “(di)ester” means that monoesters, diesters and mixtures of esters, especially of fumaric acid and/or of maleic acid, may be used. The (di)alkyl fumarates having 1 to 10 carbon atoms in the alcohol group include monomethyl fumarate, dimethyl fumarate, monoethyl fumarate, diethyl fumarate, methyl ethyl fumarate, monobutyl fumarate, dibutyl fumarate, dipentyl fumarate and dihexyl fumarate. Preferred (di)alkyl fumarates comprise 1 to 8, more preferably 1 to 4 carbon atoms in the alcohol group. The alcohol group here may be linear or branched.

The (di)alkyl maleates having 1 to 10 carbon atoms in the alcohol group include monomethyl maleate, dimethyl maleate, monoethyl maleate, diethyl maleate, methyl ethyl maleate, monobutyl maleate, dibutyl maleate. Preferred (di)alkyl maleates comprise 1 to 8, more preferably 1 to 4 carbon atoms in the alcohol group. The alcohol group here may be linear or branched.

In addition to the particularly preferred repeat units detailed above, the inventive comb polymers may comprise further repeat units which are derived from further comonomers, their proportion being at most 20% by weight, preferably at most 10% by weight and more preferably at most 5% by weight, based on the weight of the repeat units.

These also include repeat units which are derived from alkyl (meth)acrylates having 11 to 30 carbon atoms in the alcohol group, especially undecyl (meth)acrylate, 5-methylundecyl (meth)acrylate, dodecyl (meth)acrylate, 2-methyldodecyl (meth)acrylate, tridecyl (meth)acrylate, 5-methyltridecyl (meth)acrylate, tetradecyl (meth)acrylate, pentadecyl (meth)acrylate, hexadecyl (meth)acrylate, 2-methylhexadecyl (meth)acrylate, heptadecyl (meth)acrylate, 5-isopropylheptadecyl (meth)acrylate, 4-tert-butyloctadecyl (meth)acrylate, 5-ethyloctadecyl (meth)acrylate, 3-isopropyloctadecyl (meth)acrylate, octadecyl (meth)acrylate, nonadecyl (meth)acrylate, eicosyl (meth)acrylate, cetyleicosyl (meth)acrylate, stearyleicosyl (meth)acrylate, docosyl (meth)acrylate and/or eicosyltetratriacontyl (meth)acrylate.

Surprising advantages with regard to use in hydraulic fluids can be achieved especially with comb polymers having a low proportion of repeat units derived from dispersing monomers. Preference is given especially to comb polymers not having any proportion of dispersing monomers. The proportion of repeat units derived from dispersing monomers is preferably at most 2% by weight, more preferably at most 0.5% by weight and most preferably at most 0.1% by weight. In a particular aspect of the present invention, the comb polymer does not comprise any repeat units derived from dispersing monomers.

Dispersing monomers have been used for some time for functionalization of polymeric additives in lubricant oils, and are therefore known to those skilled in the art (cf. R. M. Mortier, S. T. Orszulik (eds.): “Chemistry and Technology of Lubricants”, Blackie Academic & Professional, London, 2nd ed. 1997). Appropriately, it is possible to use especially heterocyclic vinyl compounds and/or ethylenically unsaturated, polar ester compounds of the formula (I)

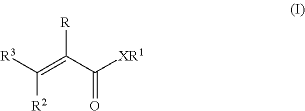

in which R is hydrogen or methyl, X is oxygen, sulfur or an amino group of the formula —NH— or —NR^{a}— in which R^{a} is an alkyl radical having 1 to 10 and preferably 1 to 4 carbon atoms, R¹ is a radical comprising 2 to 50, especially 2 to 30 and preferably 2 to 20 carbon atoms and has at least one heteroatom, preferably at least two heteroatoms, R² and R³ are each independently hydrogen or a group of the formula —COX′R^{1′} in which X′ is oxygen or an amino group of the formula —NH— or —NR^{a′} in which R^{a′} is an alkyl radical having 1 to 10 and preferably 1 to 4 carbon atoms, and R^{1′} is a radical comprising 1 to 50, preferably 1 to 30 and more preferably 1 to 15 carbon atoms, as dispersing monomers.

Examples of ethylenically unsaturated, polar ester compounds of the formula (I) include aminoalkyl (meth)acrylates, aminoalkyl(meth)acrylamides, hydroxyalkyl (meth)acrylates, heterocyclic (meth)acrylates and/or carbonyl-containing (meth)acrylates.

The hydroxyalkyl (meth)acrylates include
2-hydroxypropyl (meth)acrylate,
3,4-dihydroxybutyl (meth)acrylate,
2-hydroxyethyl (meth)acrylate,
3-hydroxypropyl (meth)acrylate,
2,5-dimethyl-1,6-hexanediol (meth)acrylate and
1,10-decanediol (meth)acrylate.

Carbonyl-containing (meth)acrylates include, for example,
2-carboxyethyl (meth)acrylate,
carboxymethyl (meth)acrylate,
oxazolidinylethyl (meth)acrylate,
N-(methacryloyloxy)formamide,
acetonyl (meth)acrylate,
mono-2-(meth)acryloyloxyethyl succinate,
N-(meth)acryloylmorpholine,
N-(meth)acryloyl-2-pyrrolidinone,
N-(2-(meth)acryloyloxyethyl)-2-pyrrolidinone,
N-(3-(meth)acryloyloxypropyl)-2-pyrrolidinone,
N-(2-(meth)acryloyloxypentadecyl)-2-pyrrolidinone,
N-(3-(meth)acryloyloxyheptadecyl)-2-pyrrolidinone and
N-(2-(meth)acryloyloxyethyl)ethyleneurea,
2-acetoacetoxyethyl (meth)acrylate.

The heterocyclic (meth)acrylates include 2-(1-imidazolyl)ethyl (meth)acrylate,
2-(4-morpholinyl)ethyl (meth)acrylate,
1-(2-methacryloyloxyethyl)-2-pyrrolidone,
N-methacryloylmorpholine,
N-methacryloyl-2-pyrrolidinone,
N-(2-methacryloyloxyethyl)-2-pyrrolidinone,
N-(3-methacryloyloxypropyl)-2-pyrrolidinone.

The aminoalkyl (meth)acrylates include especially
N,N-dimethylaminoethyl (meth)acrylate,
N,N-dimethylaminopropyl (meth)acrylate,
N,N-diethylaminopentyl (meth)acrylate,
N,N-dibutylaminohexadecyl (meth)acrylate.

Aminoalkyl(meth)acrylamides can also be used as dispersing monomers, such as
N,N-dimethylaminopropyl(meth)acrylamide.

In addition, it is possible to use phosphorus-, boron- and/or silicon-containing (meth)acrylates as dispersing monomers, such as
2-(dimethylphosphato)propyl (meth)acrylate,
2-(ethylenephosphito)propyl (meth)acrylate,
dimethylphosphinomethyl (meth)acrylate,
dimethylphosphonoethyl (meth)acrylate,
diethyl(meth)acryloyl phosphonate,
dipropyl(meth)acryloyl phosphate,
2-(dibutylphosphono)ethyl (meth)acrylate,
2,3-butylene(meth)acryloylethyl borate,
methyldiethoxy(meth)acryloylethoxysilane,
diethylphosphatoethyl (meth)acrylate.

The preferred heterocyclic vinyl compounds include 2-vinylpyridine, 3-vinylpyridine, 4-vinylpyridine, 2-methyl-5-vinylpyridine, 3-ethyl-4-vinylpyridine, 2,3-dimethyl-5-vinylpyridine, vinylpyrimidine, vinylpiperidine, 9-vinylcarbazole, 3-vinylcarbazole, 4-vinylcarbazole, 1-vinylimidazole, N-vinylimidazole, 2-methyl-1-vinylimidazole, N-vinylpyrrolidone, 2-vinylpyrrolidone, N-vinylpyrrolidine, 3-vinylpyrrolidine, N-vinylcaprolactam, N-vinylbutyrolactam, vinyloxolane, vinylfuran, vinylthiophene, vinylthiolane, vinylthiazoles and hydrogenated vinylthiazoles, vinyloxazoles and hydrogenated vinyloxazoles.

The aforementioned ethylenically unsaturated monomers may be used individually or as mixtures. It is additionally possible to vary the monomer composition during the polymerization of the main chain in order to obtain defined structures, for example block copolymers or graft polymers.

Comb polymers for use in accordance with the invention have a molar degree of branching in the range of 0.1 to 10 mol %, preferably 0.3 to 6 mol %. Particular advantages are achieved by comb polymers whose degree of branching is in the range of 0.3% to 1.1 mol %, preferably of 0.4 to 1.0 mol % and more preferably of 0.4 to 0.6 mol %. The molar degree of branching of the comb polymers f_{branch} is calculated by the formula

$${f}_{branch} = \frac{{\sum }_{a = 1}^{A} {n}_{a}}{{\sum }_{a = 1}^{A} {n}_{a} + {\sum }_{b = 1}^{B} {n}_{b}}$$

where
A=number of types of repeat units which are derived from polyolefin-based macromonomers,
B=number of types of repeat units which are derived from low molecular weight monomers selected from the group consisting of styrene monomers having 8 to 17 carbon atoms, alkyl (meth)acrylates having 1 to 10 carbon atoms in the alcohol group, vinyl esters having 1 to 11 carbon atoms in the acyl group, vinyl ethers having 1 to 10 carbon atoms in the alcohol group, (di)alkyl fumarates having 1 to 10 carbon atoms in the alcohol group, (di)alkyl maleates having 1 to 10 carbon atoms in the alcohol group, and mixtures of these monomers,
nₐ=number of repeat units which are derived from polyolefin-based macromonomers of the type a in the comb polymer molecule
n_{b}=number of repeat units which are derived from low molecular weight monomers selected from the group consisting of styrene monomers having 8 to 17 carbon atoms, alkyl (meth)acrylates having 1 to 10 carbon atoms in the alcohol group, vinyl esters having 1 to 11 carbon atoms in the acyl group, vinyl ethers having 1 to 10 carbon atoms in the alcohol group, (di)alkyl fumarates having 1 to 10 carbon atoms in the alcohol group, (di)alkyl maleates having 1 to 10 carbon atoms in the alcohol group, and mixtures of these monomers, of type b in the comb polymer molecule.

The molar degree of branching arises generally from the ratio of the monomers used if the comb polymer has been prepared by copolymerization of low molecular weight and macromolecular monomers. For the calculation, it is possible here to use the number-average molecular weight of the macromonomer.

In a particular aspect of the present invention, the comb polymer, especially the main chain of the comb polymer, may have a glass transition temperature in the range of −60 to 110° C., preferably in the range of −30 to 100° C., more preferably in the range of 0 to 90° C. and most preferably in the range of 20 to 80° C. The glass transition temperature is determined by DSC. The glass transition temperature can be estimated via the glass transition temperature of the corresponding homopolymers taking account of the proportions of the repeat units in the main chain.

The comb polymer of the present invention may preferably comprise, in the main chain, repeat units derived from polyolefin-based macromonomers, and repeat units derived from low molecular weight monomers selected from the group consisting of styrene monomers having 8 to 17 carbon atoms, alkyl (meth)acrylates having 1 to 10 carbon atoms in the alcohol group, vinyl esters having 1 to 11 carbon atoms in the acyl group, vinyl ethers having 1 to 10 carbon atoms in the alcohol group, (di)alkyl fumarates having 1 to 10 carbon atoms in the alcohol group, (di)alkyl maleates having 1 to 10 carbon atoms in the alcohol group and mixtures of these monomers, where the molar degree of branching is in the range from 0.1 to 10 mol % and the comb polymer comprises a total of at least 80% by weight, based on the weight of the repeat units, of repeat units derived from polyolefin-based macromonomers, and repeat units derived from low molecular weight monomers selected from the group consisting of styrene monomers having 8 to 17 carbon atoms, alkyl (meth)acrylates having 1 to 10 carbon atoms in the alcohol group, vinyl esters having 1 to 11 carbon atoms in the acyl group, vinyl ethers having 1 to 10 carbon atoms in the alcohol group, (di)alkyl fumarates having 1 to 10 carbon atoms in the alcohol group, (di)alkyl maleates having 1 to 10 carbon atoms in the alcohol group and mixtures of these monomers.

Comb polymers of particular interest are those with a proportion of preferably at least 80% by weight, more preferably at least 90% by weight, of low molecular weight repeat units from monomers selected from the group consisting of styrene monomers having 8 to 17 carbon atoms, alkyl (meth)acrylates having 1 to 10 carbon atoms in the alcohol group, vinyl esters having 1 to 11 carbon atoms in the acyl group, vinyl ethers having 1 to 10 carbon atoms in the alcohol group, (di)alkyl fumarates having 1 to 10 carbon atoms in the alcohol group, (di)alkyl maleates having 1 to 10 carbon atoms in the alcohol group, and mixtures of these monomers, and of repeat units derived from polyolefin-based macromonomers. This figure is based on the weight of the repeat units. In addition to the repeat units, polymers generally also comprise start groups and end groups which can form through initiation reactions and termination reactions. In a particular aspect of the present invention, the figure of at least 80% by weight, preferably at least 90% by weight, of low molecular weight repeat units derived from monomers selected from the group consisting of styrene monomers having 8 to 17 carbon atoms, alkyl (meth)acrylates having 1 to 10 carbon atoms in the alcohol group, vinyl esters having 1 to 11 carbon atoms in the acyl group, vinyl ethers having 1 to 10 carbon atoms in the alcohol group, (di)alkyl fumarates having 1 to 10 carbon atoms in the alcohol group, (di)alkyl maleates having 1 to 10 carbon atoms in the alcohol group, and mixtures of these monomers, and of repeat units derived from polyolefin-based macromonomers, is therefore based on the total weight of the comb polymers. The comb polymer has preferably 5 to 80% by weight, more preferably 30 to 70% by weight, of repeat units derived from polyolefin-based macromonomers, based on the total weight of the repeat units. In a particular aspect, preference is given to comb polymers having 8 to 30% by weight, more preferably 10 to 26% by weight, of repeat units derived from polyolefin-based macromonomers, based on the total weight of the repeat units. The polydispersity of the comb polymers is obvious to the person skilled in the art. These figures are therefore based on a mean value over all comb polymers.

Comb polymers of particular interest include those which preferably have a weight-average molecular weight M_{w} in the range from 20 000 to 1 000 000 g/mol, more preferably 50 000 to 500 000 g/mol and most preferably 150 000 to 450 000 g/mol.

The number-average molecular weight Mₙ may preferably be in the range of 20 000 to 800 000 g/mol, more preferably 40 000 to 200 000 g/mol and most preferably 50 000 to 150 000 g/mol.

Comb polymers which are additionally appropriate to the purpose are those whose polydispersity index M_{w}/Mₙ is in the range from 1 to 5, more preferably in the range from 2.5 to 4.5. The number-average and the weight-average molecular weight can be determined by known processes, for example gel permeation chromatography (GPC). This process is described in detail in WO 2007/025837, filed Aug. 4, 2006 at the European Patent Office with application number PCT/EP2006/065060, and in WO 2007/03238, filed Apr. 7, 2006 at the European Patent Office with application number PCT/EP2007/003213, the processes detailed therein for determining the molecular weight being incorporated into this application for the purposes of disclosure.

The inventive comb polymers can be prepared in various ways. A preferred process consists in the free-radical copolymerization, which is known per se, of low molecular weight monomers and macromolecular monomers.

For instance, these polymers can be prepared especially by free-radical polymerization, and also related processes for controlled free-radical polymerization, for example ATRP (=Atom Transfer Radical Polymerization) or RAFT (=Reversible Addition Fragmentation Chain Transfer).

Customary free-radical polymerization is explained, inter alia, in Ullmanns's Encyclopedia of Industrial Chemistry, Sixth Edition. In general, a polymerization initiator and a chain transferer are used for this purpose.

The usable initiators include the azo initiators well known in the technical field, such as AIBN and 1,1-azobiscyclohexanecarbonitrile, and also peroxy compounds such as methyl ethyl ketone peroxide, acetylacetone peroxide, dilauryl peroxide, tert-butyl per-2-ethylhexanoate, ketone peroxide, tert-butyl peroctoate, methyl isobutyl ketone peroxide, cyclohexanone peroxide, dibenzoyl peroxide, tert-butyl peroxybenzoate, tert-butyl peroxyisopropylcarbonate, 2,5-bis(2-ethylhexanoylperoxy)-2,5-dimethylhexane, tert-butyl peroxy-2-ethylhexanoate, tert-butyl peroxy-3,5,5-trimethylhexanoate, dicumyl peroxide, 1,1-bis(tert-butylperoxy)cyclohexane, 1,1-bis(tert-butylperoxy)-3,3,5-trimethylcyclohexane, cumyl hydroperoxide, tert-butyl hydroperoxide, bis(4-tert-butylcyclohexyl) peroxydicarbonate, mixtures of two or more of the aforementioned compounds with one another, and also mixtures of the aforementioned compounds with compounds which have not been mentioned and can likewise form free radicals. Suitable chain transferers are especially oil-soluble mercaptans, for example n-dodecyl mercaptan or 2-mercaptoethanol, or else chain transferers from the class of the terpenes, for example terpinolene.

The ATRP process is known per se. It is assumed that this is a “living” free-radical polymerization, without any intention that this should restrict the description of the mechanism. In these processes, a transition metal compound is reacted with a compound which has a transferable atom group. This transfers the transferable atom group to the transition metal compound, which oxidizes the metal. This reaction forms a radical which adds onto ethylenic groups. However, the transfer of the atom group to the transition metal compound is reversible, so that the atom group is transferred back to the growing polymer chain, which forms a controlled polymerization system. The structure of the polymer, the molecular weight and the molecular weight distribution can be controlled correspondingly.

This reaction is described, for example, by J-S. Wang, et al., J. Am. Chem. Soc., vol. 117, p. 5614-5615 (1995), by Matyjaszewski, Macromolecules, vol. 28, p. 7901-7910 (1995). In addition, the patent applications WO 96/30421, WO 97/47661, WO 97/18247, WO 98/40415 and WO 99/10387, disclose variants of the ATRP explained above.

In addition, the inventive polymers may be obtained, for example, also via RAFT methods. This process is presented in detail, for example, in WO 98/01478 and WO 2004/083169.

The polymerization may be carried out at standard pressure, reduced pressure or elevated pressure. The polymerization temperature too is uncritical. However, it is generally in the range of −20°-200° C., preferably 50°-150° C. and more preferably 80°-130° C.

The polymerization can be performed with or without solvent. The term solvent should be understood here in a broad sense. The solvent is selected according to the polarity of the monomers used, and it is preferable to use 100N oil, relatively light gas oil and/or aromatic hydrocarbons, for example toluene or xylene.

The low molecular weight monomers to be used for preparation of the inventive comb polymers in a free-radical copolymerization are generally commercially available.

Macromonomers usable in accordance with the invention have exactly one free-radically polymerizable double bond, which is preferably terminal.

The double bond here may be present as a result of the preparation of the macromonomers. For example, a cationic polymerization of isobutylene forms a polyisobutylene (PIB) which has a terminal double bond.

In addition, functionalized polyolefinic groups may be converted to a macromonomer by suitable reactions.

For example, macroalcohols and/or macroamines based on polyolefins may be subjected to a transesterification or aminolysis with low molecular weight monomers which have at least one unsaturated ester group, for example methyl (meth)acrylate or ethyl (meth)acrylate.

This transesterification is widely known. For example, a heterogeneous catalyst system can be used for this purpose, such as lithium hydroxide/calcium oxide mixture (LiOH/CaO), pure lithium hydroxide (LiOH), lithium methoxide (LiOMe) or sodium methoxide (NaOMe) or a homogeneous catalyst system, such as isopropyl titanate (Ti(OiPr)₄) or dioctyltin oxide (Sn(Oct)₂O). The reaction is an equilibrium reaction. The low molecular weight alcohol released is therefore typically removed, for example, by distillation.

Particularly surprisingly, improved separation of water (demulsification) can be achieved according to ASTM 1401 by catalyzing the transesterification with a lithium hydroxide/calcium oxide mixture (LiOH/CaO) or pure lithium hydroxide (LiOH). Reaction mixtures which have been converted by these catalysts can be purified by means of filters. Surprising advantages can especially be achieved using depth filters, which are preferably obtainable under the Seitz T1000 name. The macromonomers thus prepared surprisingly lead to hydraulic fluids which exhibit a particularly low demulsification value.

In addition, these macromonomers can be obtained by a direct esterification or direct amidation proceeding, for example, from methacrylic acid or methacrylic anhydride, preferably with acidic catalysis by p-toluenesulfonic acid or methanesulfonic acid or from free methacrylic acid by the DCC method (dicyclohexylcarbodiimide).

In addition, the present alcohol or the amide can be converted to a macromonomer by reaction with an acid chloride, such as (meth)acryloyl chloride.

In addition, it is also possible to prepare a macroalcohol via the reaction of the terminal PIB double bond, as forms in cationically polymerized PIB, with maleic anhydride (ene reaction) and subsequent reaction with an α,ω-amino alcohol.

Moreover, suitable macromonomers can be obtained by reacting a terminal PIB double bond with methacrylic acid or by a Friedel-Crafts alkylation of the PIB double bond onto styrene.

In the preparations of the macromonomers detailed above, preference is given to using polymerization inhibitors, for example 4-hydroxy-2,2,6,6-tetramethyl-piperidine oxyl radical and/or hydroquinone monomethyl ether.

The macroalcohols and/or macroamines which are based on polyolefins and are to be used for the reactions detailed above can be prepared in a known manner.

In addition, some of these macroalcohols and/or macroamines are commercially available.

The commercially available macroamines include, for example, Kerocom® PIBA 03. Kerocom® PIBA 03 is a polyisobutylene (PIB) of Mₙ=1000 g/mol which has been NH₂-functionalized to an extent of about 75% by weight and is supplied as a concentrate of about 65% by weight in aliphatic hydrocarbons by BASF AG (Ludwigshafen, Germany).

A further product is Kraton Liquid® L-1203, a hydrogenated polybutadiene which has been OH-functionalized to an extent of about 98% by weight (also known as olefin copolymer OCP) and has about 50% each of 1,2 repeat units and 1,4 repeat units of Mₙ=4200 g/mol, from Kraton Polymers GmbH (Eschborn, Germany).

Further suppliers of suitable macroalcohols based on hydrogenated polybutadiene are Cray Valley (Paris), a daughter company of Total (Paris), and the Sartomer Company (Exton/Pa./USA).

The preparation of macroamines is described, for example, in EP 0 244 616 to BASF AG. The macroamines are prepared via hydroformylation and amination, preferably of polyisobutylene. Polyisobutylene offers the advantage of not exhibiting any crystallization at low temperatures.

Advantageous macroalcohols may additionally be prepared according to the known patents to BASF AG, either via hydroboration (WO 2004/067583) of highly reactive polyisobutylene HR-PIB (EP 0 628 575), which contains an elevated proportion of terminal α-double bonds, or by hydroformylation followed by hydrogenation (EP 0 277 345). Compared to hydroformylation and hydrogenation, hydroboration affords higher alcohol functionalities.

Preferred macroalcohols based on hydrogenated polybutadienes can be obtained according to GB 2270317 to Shell International Research Maatschappij. A high proportion of 1,2 repeat units of about 60% and more can lead to significantly lower crystallization temperatures.

Some of the macromonomers detailed above are also commercially available, for example Kraton Liquid® L-1253, which is produced from Kraton Liquid® L-1203 and is a hydrogenated polybutadiene which has been methacrylate-functionalized to an extent of about 96% by weight and has about 50% each of 1,2 repeat units and 1,4 repeat units, from Kraton Polymers GmbH (Eschborn, Germany).

Kraton® L-1253 was synthesized according to GB 2270317 to Shell International Research Maatschappij.

Macromonomers based on polyolefins and their preparation are also detailed in EP 0 621 293 and EP 0 699 694.

In addition to a free-radical copolymerization of macromonomers and low molecular weight monomers which has been detailed above, the inventive comb polymers may be obtained by polymer-analogous reactions.

In this case, a polymer is first prepared in a known manner from low molecular weight monomers and is then converted. In this case, the backbone of a comb polymer may be synthesized from a reactive monomer such as maleic anhydride, methacrylic acid or else glycidyl methacrylate and other unreactive short-chain backbone monomers. In this case, the initiator systems detailed above, such as t-butyl perbenzoate or t-butyl per-2-ethylhexanoate, and regulators such as n-dodecyl mercaptan may find use.

In a further step, for example in an alcoholysis or aminolysis, the side chains, which are also referred to as arms, may be generated. In this reaction, the macroalcohols and/or macroamines detailed above may be used.

The reaction of the initially formed backbone polymer with macroalcohols and/or macroamines corresponds essentially to the reactions detailed above of the macroalcohols and/or macroamines with low molecular weight compounds.

For example, the macroalcohols and/or macroamines may be converted to the inventive comb polymers in grafting reactions known per se, for example onto the present maleic anhydride or methacrylic acid functionalities in the backbone polymer with catalysis, for example, by p-toluenesulfonic acid or methanesulfonic acid to give esters, amides or imides. Addition of low molecular weight alcohols and/or amines, such as n-butanol or N-(3-aminopropyl)morpholine, allows this polymer-analogous reaction to be conducted to complete conversions, especially in the case of maleic anhydride backbones.

In the case of glycidyl functionalities in the backbone, an addition of the macroalcohol and/or of the macroamine can be performed so as to form comb polymers.

In addition, the macroalcohols and/or the macroamines can be converted by a polymer-analogous alcoholysis or aminolysis with a backbone which contains short-chain ester functionalities in order to generate comb polymers.

In addition to the reaction of the backbone polymer with macromolecular compounds, suitably functionalized polymers which have been obtained by reacting low molecular weight monomers with further low molecular weight monomers to form comb polymers can be reacted. In this case, the initially prepared backbone polymer has a plurality of functionalities which serve as initiators of multiple graft polymerizations.

For instance, a multiple cationic polymerization of i-butene can be initiated, which leads to comb polymers with polyolefin side arms. Suitable processes for such graft copolymerizations are also the ATRP and/or RAFT processes detailed above in order to obtain comb polymers with a defined architecture.

In a particular aspect of the present invention, comb polymers for use in accordance with the present invention have a low proportion of olefinic double bonds. The iodine number is preferably less than or equal to 0.2 g per g of comb polymer, more preferably less than or equal to 0.1 g per g of comb polymer. This proportion can be determined to DIN 53241 after drawing off carrier oil and low molecular weight residual monomers at 180° C. under reduced pressure for 24 hours.

Particularly effective comb polymers comprise at least 10% by weight of repeat units derived from styrene monomers having 8 to 17 carbon atoms, at least 5% by weight of repeat units derived from alkyl (meth)acrylates having 1 to 6 carbon atoms, and repeat units derived from dispersing monomers.

In a preferred embodiment, the comb polymer may have 30 to 60% by weight, more preferably 35 to 50% by weight, of repeat units derived from polyolefin-based macromonomers with a molecular weight of at least 500 g/mol. These figures are based here on the total weight of repeat units of the comb polymer. These figures result from the weight ratios of the monomers in the preparation of the comb polymer. These monomers have been detailed above, and reference is made to these details.

Styrene monomers and alkyl (meth)acrylates having 1 to 6 carbon atoms have been detailed above, and n-butyl methacrylate can be used with particular preference for preparation of the inventive viscosity index-improving comb polymers with VI action.

Particular advantages with regard to improvement of load-bearing capacity can be achieved especially by comb polymers which have repeat units derived from styrene and repeat units derived from n-butyl methacrylate. Of particular interest are especially comb polymers with VI action in which the weight ratio of repeat units derived from styrene to the repeat units derived from n-butyl methacrylate is in the range from 10:1 to 1:10, more preferably in the range from 4:1 to 1.5:1.

In a particular modification of the present invention, the ratio of the number-average molecular weight Mₙ of the polyolefin-based macromonomer to the number-average molecular weight Mₙ of the comb polymer with VI action is in the range from 1:10 to 1:50, more preferably 1:15 to 1:45.

Surprising advantages are achieved by comb polymers which preferably have repeat units derived from methyl methacrylate and repeat units derived from alkyl (meth)acrylates having 8 to 30 carbon atoms in the alcohol group.

The comb polymers for use in accordance with the invention are used in a hydraulic fluid. A hydraulic fluid is a composition which is liquid at operating temperature of the hydraulic system and is suitable for use in a hydraulic system.

The inventive hydraulic fluid preferably comprises at least one lubricant oil.

The lubricant oils include especially mineral oils, synthetic oils and natural oils.

Mineral oils are known per se and commercially available. They are generally obtained from mineral oil or crude oil by distillation and/or refining and optionally further purification and finishing processes, the term “mineral oil” including in particular the higher-boiling fractions of crude or mineral oil. In general, the boiling point of mineral oil is higher than 200° C., preferably higher than 300° C., at 5000 Pa. The production by low-temperature carbonization of shale oil, coking of bituminous coal, distillation of brown coal with exclusion of air, and also hydrogenation of bituminous or brown coal is likewise possible. Accordingly, mineral oils have, depending on their origin, different proportions of aromatic, cyclic, branched and linear hydrocarbons.

In general, a distinction is drawn between paraffin-base, naphthenic and aromatic fractions in crude oils or mineral oils, in which the term “paraffin-base fraction” represents longer-chain or highly branched isoalkanes, and “naphthenic fraction” represents cycloalkanes. In addition, mineral oils, depending on their origin and finishing, have different fractions of n-alkanes, isoalkanes having a low degree of branching, known as mono-methyl-branched paraffins, and compounds having heteroatoms, in particular O, N and/or S, to which a degree of polar properties are attributed. However, the assignment is difficult, since individual alkane molecules may have both long-chain branched groups and cycloalkane radicals, and aromatic parts. For the purposes of the present invention, the assignment can be effected to DIN 51 378, for example. Polar fractions can also be determined to ASTM D 2007.

The proportion of n-alkanes in preferred mineral oils is less than 3% by weight, the fraction of O-, N- and/or S-containing compounds less than 6% by weight. The fraction of the aromatics and of the mono-methyl-branched paraffins is generally in each case in the range from 0 to 40% by weight. In one interesting aspect, mineral oil comprises mainly naphthenic and paraffin-base alkanes which have generally more than 13, preferably more than 18 and most preferably more than 20 carbon atoms. The fraction of these compounds is generally ≧60% by weight, preferably ≧80% by weight, without any intention that this should impose a restriction. A preferred mineral oil contains 0.5 to 30% by weight of aromatic fractions, 15 to 40% by weight of naphthenic fractions, 35 to 80% by weight of paraffin-base fractions, up to 3% by weight of n-alkanes and 0.05 to 5% by weight of polar compounds, based in each case on the total weight of the mineral oil.

An analysis of particularly preferred mineral oils, which was effected by means of conventional processes such as urea separation and liquid chromatography on silica gel, shows, for example, the following constituents, the percentages relating to the total weight of the particular mineral oil used:

n-alkanes having approx. 18 to 31 carbon atoms:
0.7-1.0%,
slightly branched alkanes having 18 to 31 carbon atoms:
1.0-8.0%,
aromatics having 14 to 32 carbon atoms:
0.4-10.7%,
iso- and cycloalkanes having 20 to 32 carbon atoms:
60.7-82.4%,
polar compounds:
0.1-0.8%,
loss:
6.9-19.4%.

An improved class of mineral oils (reduced sulfur content, reduced nitrogen content, higher viscosity index, lower pour point) results from hydrogen treatment of the mineral oils (hydroisomerization, hydrocracking, hydrotreatment, hydrofinishing). In the presence of hydrogen, this essentially reduces aromatic components and builds up naphthenic components.

Valuable information with regard to the analysis of mineral oils and a list of mineral oils which have a different composition can be found, for example, in Ullmann's Encyclopedia of Industrial Chemistry, 5th Edition on CD-ROM, 1997, under “lubricants and related products”.

Synthetic oils include organic esters, for example diesters and polyesters, polyalkylene glycols, polyethers, synthetic hydrocarbons, especially polyolefins, among which preference is given to polyalphaolefins (PAOs), silicone oils and perfluoroalkyl ethers. In addition, it is possible to use synthetic base oils originating from gas to liquid (GTL), coal to liquid (CTL) or biomass to liquid (BTL) processes. They are usually somewhat more expensive than the mineral oils, but have advantages with regard to their performance.

Natural oils are animal or vegetable oils, for example neatsfoot oils or jojoba oils.

Base oils for lubricant oil formulations are divided into groups according to API (American Petroleum Institute). Mineral oils are divided into group I (non-hydrogen-treated) and, depending on the degree of saturation, sulfur content and viscosity index, into groups II and III (both hydrogen-treated). PAOs correspond to group IV. All other base oils are encompassed in group V.

The lubricant oils (base oils) used may especially be oils having a viscosity in the range from 3 mm²/s to 100 mm²/s, more preferably 13 mm²/s to 65 mm²/s, measured at 40° C. to ASTM 445. The use of these base oils allows surprising advantages to be achieved with regard to energy requirement.

These lubricant oils may also be used as mixtures and are in many cases commercially available.

The concentration of the comb polymer in the lubricant oil composition, i.e. the hydraulic fluid, is preferably in the range from 0.1 to 40% by weight, especially preferably in the range from 1 to 30% by weight, more preferably in the range from 2 to 20% by weight and most preferably in the range of 5-15% by weight, based on the total weight of the composition.

In addition to the components mentioned above, a lubricant oil composition may comprise further additives. Preferred additives may especially be based on a linear polyalkyl (meth)acrylate having 1 to 30 carbon atoms in the alcohol group (PAMA). These additives include DI additives (dispersants, detergents, defoamers, corrosion inhibitors, antioxidants, antiwear and extreme pressure additives, friction modifiers), pour point improvers (more preferably based on polyalkyl (meth)acrylate having 1 to 30 carbon atoms in the alcohol group), and/or dyes.

In addition, the hydraulic fluids detailed here may also be present in mixtures with conventional VI improvers. These include especially hydrogenated styrene-diene copolymers (HSDs, U.S. Pat. No. 4,116,917, U.S. Pat. No. 3,772,196 and U.S. Pat. No. 4,788,316 to Shell Oil Company), especially based on butadiene and isoprene, and also olefin copolymers (OCPs, K. Marsden: “Literature Review of OCP Viscosity Modifiers”, Lubrication Science 1 (1988), 265).

Compilations of VI improvers and pour point improvers for lubricant oils, especially motor oils, are detailed, for example, in T. Mang, W. Dresel (eds.): “Lubricants and Lubrication”, Wiley-VCH, Weinheim 2001, R. M. Mortier, S. T. Orszulik (eds.): “Chemistry and Technology of Lubricants”, Blackie Academic & Professional, London 1992; or J. Bartz: “Additive für Schmierstoffe” (Additives for Lubricants), Expert-Verlag, Renningen-Malmsheim 1994.

Of particular interest are additionally defoamers, which are in many cases divided into silicone-containing and silicone-free defoamers. The silicone-containing defoamers include linear poly(dimethylsiloxane) and cyclic poly(dimethylsiloxane). The silicone-free defoamers which may be used are in many cases polyethers, for example poly(ethylene glycol) or tributyl phosphate. Particular advantages can be achieved by copolymers based on polyalkyl (meth)acrylates which have units derived from alkoxylated (meth)acrylates.

In a particular embodiment, the inventive lubricant oil compositions may comprise corrosion inhibitors. These are in many cases divided into antirust additives and metal passivators/deactivators. The antirust additives used may, inter alia, be sulfonates, for example petroleumsulfonates or (in many cases overbased) synthetic alkylbenzenesulfonates, e.g. dinonylnaphthenesulfonate; carboxylic acid derivatives, for example lanolin (wool fat), oxidized paraffins, zinc naphthenates, alkylated succinic acids, 4-nonylphenoxy-acetic acid, amides and imides (N-acylsarcosine, imidazoline derivatives); amine-neutralized mono- and dialkyl phosphates; morpholine; dicyclohexylamine or diethanolamine. The metal passivators/deactivators include benzotriazole, tolyltriazole, 2-mercaptobenzothiazole, dialkyl-2,5-dimercapto-1,3,4-thiadiazole; N,N′-disalicylideneethylenediamine, N,N′-disalicylidenepropylenediamine; zinc dialkyldithiophosphates and dialkyl dithiocarbamates.

A further preferred group of additives is that of antioxidants. The antioxidants include, for example, phenols, for example 2,6-di-tert-butylphenol (2,6-DTB), butylated hydroxytoluene (BHT), 2,6-di-tert-butyl-4-methylphenol, 4,4′-methylenebis(2,6-di-tert-butylphenol); aromatic amines, especially alkylated diphenylamines, N-phenyl-1-naphthylamine (PNA), polymeric 2,2,4-trimethyl-dihydroquinone (TMQ); compounds containing sulfur and phosphorus, for example metal dithiophosphates, e.g. zinc dithiophosphates (ZnDTP), “OOS triesters”=reaction products of dithiophosphoric acid with activated double bonds from olefins, cyclopentadiene, norbornadiene, α-pinene, polybutene, acrylic esters, maleic esters (ashless on combustion); organosulfur compounds, for example dialkyl sulfides, diaryl sulfides, polysulfides, modified thiols, thiophene derivatives, xanthates, thioglycols, thioaldehydes, sulfur-containing carboxylic acids; heterocyclic sulfur/nitrogen compounds, especially dialkyldimercaptothiadiazoles, 2-mercaptobenzimidazoles; zinc and methylene bis(dialkyldithiocarbamate); organophosphorus compounds, for example triaryl and trialkyl phosphites; organocopper compounds and overbased calcium- and magnesium-based phenoxides and salicylates.

The preferred antiwear (AW) and extreme pressure (EP) additives include phosphorus compounds, for example trialkyl phosphates, triaryl phosphates, e.g. tricresyl phosphate, amine-neutralized mono- and dialkyl phosphates, ethoxylated mono- and dialkyl phosphates, phosphites, phosphonates, phosphines; compounds containing sulfur and phosphorus, for example metal dithiophosphates, e.g. zinc C₃₋₁₂dialkyldithiophosphates (ZnDTPs), ammonium dialkyldithiophosphates, antimony dialkyldithiophosphates, molybdenum dialkyldithiophosphates, lead dialkyldithiophosphates, “OOS triesters”=reaction products of dithiophosphoric acid with activated double bonds from olefins, cyclopentadiene, norbornadiene, α-pinene, polybutene, acrylic esters, maleic esters, triphenylphosphorothionate (TPPT); compounds containing sulfur and nitrogen, for example zinc bis(amyl dithiocarbamate) or methylenebis(di-n-butyl dithiocarbamate); sulfur compounds containing elemental sulfur and H₂S-sulfurized hydrocarbons (diisobutylene, terpene); sulfurized glycerides and fatty acid esters; overbased sulfonates; chlorine compounds or solids such as graphite or molybdenum disulfide.

A further preferred group of additives is that of friction modifiers. The friction modifiers used may include mechanically active compounds, for example molybdenum disulfide, graphite (including fluorinated graphite), poly(trifluoroethylene), polyamide, polyimide; compounds which form adsorption layers, for example long-chain carboxylic acids, fatty acid esters, ethers, alcohols, amines, amides, imides; compounds which form layers through tribochemical reactions, for example saturated fatty acids, phosphoric acid and thiophosphoric esters, xanthogenates, sulfurized fatty acids; compounds which form polymer-like layers, for example ethoxylated dicarboxylic acid partial esters, dialkyl phthalates, methacrylates, unsaturated fatty acids, sulfurized olefins or organometallic compounds, for example molybdenum compounds (molybdenum dithiophosphates and molybdenum dithiocarbamates MoDTC) and their combinations with ZnDTPs, copper-containing organic compounds.

Some of the compounds detailed above may fulfill multiple functions. ZnDTP, for example, is primarily an antiwear additive and extreme pressure additive, but also has the character of an antioxidant and corrosion inhibitor (here: metal passivator/deactivator).

The additives detailed above are described in more detail, inter alia, in T. Mang, W. Dresel (eds.): “Lubricants and Lubrication”, Wiley-VCH, Weinheim 2001; R. M. Mortier, S. T. Orszulik (eds.): “Chemistry and Technology of Lubricants”.

The demulsification value of a hydraulic fluid claimed in accordance with the invention is less than 30 minutes, preferably less than 15 minutes, more preferably less than 10 minutes and most preferably less than 5 minutes. By virtue of this property, the inventive hydraulic fluids exhibit a particularly high energy efficiency and a very high load-bearing capacity. The demulsification value is measured to ASTM D 1401, by preparing a mixture of water and hydraulic fluid in a cylinder and emulsifying it under controlled conditions. The time until the emulsion has separated is determined (for example less than 3 ml of residual emulsion is present).

Preferred hydraulic fluids have a viscosity, measured at 40° C. to ASTM D 445, in the range of 10 to 120 mm²/s, more preferably in the range of 22 to 100 mm²/s. The kinematic viscosity KV₁₀₀ measured at 100° C. is preferably at least 5.5 mm²/s, more preferably at least 5.6 mm²/s and most preferably at least 5.8 mm²/s.

In a particular aspect of the present invention, preferred hydraulic fluids have a viscosity index determined to ASTM D 2270 in the range from 100 to 400, more preferably in the range from 150 to 350 and most preferably in the range from 175 to 275.

In an appropriate modification, the permanent shear stability index (PSSI) to ASTM D2603 Ref. B (ultrasound treatment for 12.5 minutes) may be less than or equal to 35, more preferably less than or equal to 20. Advantageously, it is also possible to obtain lubricant oil compositions which have a permanent shear stability index (PSSI) to DIN 51381 (30 cycles on a Bosch pump) of at most 5, preferably at most 2 and most preferably at most 1.

The load-bearing capacity, also called scuffing load capacity, of an inventive hydraulic fluid is determined with a gear rig test machine according to FZG (Gear Research Center of the Technical University of Munich) to DIN 51354-2 or DIN ISO 14635-1. Preferred hydraulic fluids of the present invention have a load-bearing capacity or load stage of at least 8, more preferably at least 11 and most preferably at least 12.

An inventive hydraulic fluid preferably exhibits an overall efficiency at least 2% higher, preferably at least 5% higher, than a hydraulic fluid with the same KV₄₀ having a viscosity index of 100. These values can surprisingly be achieved at high temperatures and high pressures, especially at a pump inlet temperature of 100° C. and a pressure of 250 bar. Processes for determining the overall efficiency are described especially in Neveu, C. D. et al.; “Achieving Efficiency Improvements through Hydraulic Fluid Selection: Laboratory Prediction and Field Evaluation” in STLE (STLE=Society of Tribologists and Lubrication Engineers) from 2007.

These hydraulic fluids exhibit particular advantages in a vane pump, a gear pump, a radial piston pump, an axial piston pump or a hydraulic motor.

The present invention will be illustrated in detail hereinafter with reference to examples and comparative examples, without any intention that this should impose a restriction.

### Preparation of the Macromonomer

The macroalcohol used was a hydroxyethyl-terminated, hydrogenated polybutadiene with a mean molar mass Mn=4800 g/mol. The vinyl content of the macromonomer was 55%, the degree of hydrogenation>98.5% and the —OH functionality>90%; all these values were determined by H NMR (nuclear resonance spectroscopy).

In a 2 l stirred apparatus equipped with a saber stirrer, air inlet tube, thermocouple with regulator, heating mantle, column packed with 4 mm Raschig ring random packings, vapor divider, top thermometer, reflux condenser and substrate condenser, 1200 g of macroalcohol were dissolved in 400 g of MMA by stirring at 60° C. 32 mg of 2,2,6,6-tetramethylpiperidine-1-oxyl radical and 320 mg of hydroquinone monomethyl ether were added to the solution. After heating to MMA reflux (bottom temperature about 110° C.) while passing air through for stabilization, about 20 g of MMA were distilled off for azeotropic drying. After cooling to 95° C., 0.30 g of LiOH was added and the mixture was heated again to reflux. After a reaction time of approx. 1 hour, the top temperature had fallen to ˜64° C. due to methanol formation. The methanol/MMA azeotrope formed was constantly distilled off until a constant top temperature of about 100° C. was established again. At this temperature, the mixture was allowed to react for a further hour. For further workup, the bulk of MMA was drawn off under reduced pressure and then the viscous “crude macromonomer” was diluted by adding 514.3 g of KPE 100N oil. Insoluble catalyst residues were removed by pressure filtration (Seitz T1000 depth filter). This gave approx. 1650 g of macromonomer solution in oil. The content of KPE 100N oil in the comb polymer syntheses described below was taken into account correspondingly.

### ABBREVIATIONS

In the description which follows, the following abbreviations are used:

MM 1: methacrylic ester of the above-described macroalcohol
AMA: methacrylic ester of a linear C12-C14 alcohol
BMA: n-butyl methacrylate
MMA: methyl methacrylate
Sty: styrene
BDtBPB: 2,2-bis(tert-butylperoxy)butane

### Preparation of the Comb Polymers

### Comb Polymer 1

In a vessel, the following reaction mixture was made up: 2.286 kg of 70% macromonomer solution in oil, 12.8 g of AMA, 4.067 kg of BMA, 0.707 kg of Sty, 12.8 g of MMA, 2.773 kg of Shell Risella 907 (light naphthenic/paraffinic base oil) and 0.808 kg of KPE 100N oil. A 20 l stirred apparatus with stirrer, nitrogen blanketing, thermometer, regulated oil thermostat and reflux condenser was initially charged with 2.1 kg of the reaction mixture which were heated to 115° C. while stirring. During the heating phase, nitrogen was passed through the apparatus for inertization. On attainment of 115° C., 1.26 g of BDtBPB were introduced into the initial charge; at the same time, the feed consisting of the rest of the reaction mixture and 5.12 g of BDtBPB was commenced. The feed time was 3 hours; the reaction temperature was kept constant at 115° C. 3 and 6 hours after the end of the feed, another 12.8 g of BDtBPB were added in each case and the contents of the reactor were diluted to a solids content of 40% the next day by adding oil. 16.0 kg of a high-viscosity, clear solution were obtained.

### Comb Polymer 2

In a vessel, the following reaction mixture was made up: 3.84 kg of 70% macromonomer solution in oil, 12.8 g of AMA, 1.139 kg of BMA, 2.547 kg of Sty, 12.8 g of MMA, 2.773 kg of Shell Risella 907 (light naphthenic/paraffinic base oil) and 0.34 kg of KPE 100N oil. A 20 l stirred apparatus with stirrer, nitrogen blanketing, thermometer, regulated oil thermostat and reflux condenser was initially charged with 2.1 kg of the reaction mixture which were heated to 120° C. while stirring. During the heating phase, nitrogen was passed through the apparatus for inertization. On attainment of 120° C., 2.52 g of BDtBPB were introduced into the initial charge; at the same time, the feed consisting of the rest of the reaction mixture and 10.24 g of BDtBPB was commenced. The feed time was 3 hours; the reaction temperature was kept constant at 120° C. 3 and 6 hours after the end of the feed, another 12.8 g of BDtBPB were added in each case and the contents of the reactor were diluted to a solids content of 40% the next day by adding oil. 16.0 kg of a high-viscosity, clear solution were obtained.

### EXAMPLES 1 AND 2 AND COMPARATIVE EXAMPLES 1 AND 2

The properties of the comb polymers detailed above with respect to improvement of the load-bearing capacity were examined. For this purpose, the compositions detailed in table 1 below were prepared, by stirring at 80° C. for at least 60 min after all components have been weighed in. Clear homogeneous solutions were obtained. The base oils used were deparaffinized raffinates of different viscosities from ExxonMobil; all oils used correspond to group I according to the API classification of mineral oils.

All oils contain the same added amount of a commercial hydraulic DI package (DI=detergent inhibitor) from Afton Chemical, Hitech 521. This DI package contains not only antioxidants, antirust agents and detergents but also zinc-containing antiwear components and EP additives.

Table 1 shows all details of the composition in percent by mass.

TABLE 1
Load-bearing capacity of different hydraulic fluids

| | | KV100 base oil | |
|---|---|---|---|
| | Formulation | [mm²/s] | FZG Test LS |
| Comparative | 0.95% H521 | 6.857 | 12 |
| example 1 | 65.0% 150N oil | | |
| | 34.05% 600N oil | | |
| Comparative | 0.95% H521 | 5.857 | 11 |
| example 2 | 31.64% 80N oil | | |
| | 33.90% 150N oil | | |
| | 33.51% 600N oil | | |
| Example 1 | 11.4% comb polymer 1 | 5.978 | 12 |
| | 0.95% H521 | | |
| | 28% 80N oil | | |
| | 30% 150N oil | | |
| | 29.65% 600N oil | | |
| Example 2 | 10.7% comb polymer 2 | 5.221 | 12 |
| | 0.95% H521 | | |
| | 32% 80N oil | | |
| | 40% 150N oil | | |
| | 16.35 600N oil | | |

Comparative formulations 1 and 2 show how the load-bearing capacity of the formulation with the same DI additization deteriorates as the base oil viscosity decreases. In contrast, it is clearly evident from examples 1 and 2 that the load-bearing capacity is very high in spite of very low base oil viscosities. The use of comb polymers in hydraulic oils can accordingly contribute to a distinct improvement in the wear characteristics of modern multigrade oils.

### EXAMPLE 3 AND COMPARATIVE EXAMPLES 3 AND 4

An inventive hydraulic fluid containing the above-described comb polymer 1 was studied for overall efficiency compared to a formulation containing a commercially available Viscoplex VI improver and containing a monograde oil on a hydraulic pump test bed. The test setup and the procedure are described in great detail in the publication by Neveu, C. D. et al.; “Achieving Efficiency Improvements through Hydraulic Fluid Selection: Laboratory Prediction and Field Evaluation” in STLE (STLE=Society of Tribologists and Lubrication Engineers) from 2007, except that a Denison T6 vent pump which was operated at a constant 1500 rpm with the aid of an electric motor was used instead of an Eaton Vickers V104C pump. The overall pump efficiency was determined at 3 different pressures of 150 and 250 bar, in each case at pump inlet temperature 80° C. and 100° C. The calculation formulae needed for evaluation are likewise described in detail in the abovementioned publication.

Table 2 shows the viscometric data of the hydraulic fluids tested, and table 3 the results of the pump efficiency test.

TABLE 2
Viscometric data of the hydraulic fluids tested

| | | KV40° C. | KV100° C. | |
|---|---|---|---|---|
| | Formulation | [mm²/s] | [mm²/s] | VI |
| Comparative | ExxonMobil | 45.95 | 6.787 | 101 |
| example 3 | monograde | | | |
| Comparative | 14.6% Viscoplex 8-200 | 46.16 | 9.699 | 202 |
| example 4 | 0.6% Oloa 4992 | | | |
| | 19.9% 80N oil | | | |
| | 64.9% 100N oil | | | |
| Example 3 | 7.4% comb polymer 1 | 47.32 | 8.82 | 168 |
| | 0.95% H521 | | | |
| | 22.4% Esso 80 | | | |
| | 32.7% Esso 150 | | | |
| | 36.55 Esso 600 | | | |

TABLE 3
Results of the pump efficiency test

| | Pump inlet | Pressure | Overall |
|---|---|---|---|
| | temperature [° C.] | [bar] | efficiency [%] |
| Comparative example | 80 | 150 | 70.5 |
| 3 | | | |
| Comparative example | 80 | 150 | 71.8 |
| 4 | | | |
| Example 3 | 80 | 150 | 72.0 |
| Comparative example | 80 | 250 | 51.1 |
| 3 | | | |
| Comparative example | 80 | 250 | 54.1 |
| 4 | | | |
| Example 3 | 80 | 250 | 54.4 |
| Comparative example | 100 | 150 | 59.9 |
| 3 | | | |
| Comparative example | 100 | 150 | 62.3 |
| 4 | | | |
| Example 3 | 100 | 150 | 62.7 |
| Comparative example | 100 | 250 | 31.5 |
| 3 | | | |
| Comparative example | 100 | 250 | 38.7 |
| 4 | | | |
| Example 3 | 100 | 250 | 39.3 |

As table 3 shows, the efficiencies of the inventive comb polymer formulation are measurably higher in spite of a lower viscosity index. The use of comb polymers can accordingly contribute, by virtue of the improved efficiency, to lowering the primary energy requirement of the hydraulic systems.

1. A comb polymer, comprising, in a main chain, at least one repeat unit corresponding to at least one polyolefin-based macromonomer with a molecular weight of at least 500 g/mol, and at least one repeat unit corresponding to at least one low molecular weight monomer with a molecular weight less than 500 g/mol, wherein the comb polymer is suitable for improving the load-bearing capacity of at least one hydraulic fluid.

2. The polymer of claim 1, wherein the hydraulic fluid comprises a lubricant oil.

3. The polymer of claim 1, wherein the hydraulic fluid is suitable for a vane pump, a gear pump, a radial piston pump, an axial piston pump or a hydraulic motor.

4. A hydraulic fluid, comprising at least one lubricant oil and at least one polymer,
wherein
the at least one polymer is a comb polymer comprising, in a main chain, at least one repeat unit corresponding to at least one polyolefin-based macromonomer with a molecular weight of at least 500 g/mol, and at least one repeat unit corresponding to at least one low molecular weight monomer with a molecular weight less than 500 g/mol, and
the hydraulic fluid has a demulsification value of less than 30 minutes.

5. The hydraulic fluid of claim 4, wherein the hydraulic fluid has a demulsification value of less than 15 minutes.

6. The hydraulic fluid of claim 4, wherein the hydraulic fluid comprises 1 to 30% by weight of the comb polymer.

7. The hydraulic fluid of claim 4, wherein
a molar degree of branching is in the range from 0.1 to 10 mol %, and
the comb polymer comprises a total of at least 80% by weight, based on the weight of all repeat units, of the at least one repeat unit corresponding to the at least one polyolefin-based macromonomer, and the at least one repeat unit corresponding to at least one low molecular weight monomer selected from the group consisting of a styrene monomer having 8 to 17 carbon atoms, an alkyl (meth)acrylate having 1 to 10 carbon atoms in the alcohol group, a vinyl ester having 1 to 11 carbon atoms in the acyl group, a vinyl ether having 1 to 10 carbon atoms in the alcohol group, a (di)alkyl fumarate having 1 to 10 carbon atoms in the alcohol group, and a (di)alkyl maleates having 1 to 10 carbon atoms in the alcohol group.

8. The hydraulic fluid of claim 7, wherein the molar degree of branching is in the range from 0.3 to 3.6 mol %.

9. The hydraulic fluid of claim 4, wherein the comb polymer comprises 20 to 60% by weight of the at least one repeat unit corresponding to the at least one polyolefin-based macromonomer with a molecular weight of at least 500 g/mol.

10. The hydraulic fluid of claim 4, wherein the comb polymer comprises at least one repeat unit corresponding to styrene and at least one repeat unit corresponding to n-butyl methacrylate.

11. The hydraulic fluid of claim 10, wherein a weight ratio of the at least one repeat unit corresponding to styrene to the at least one repeat unit corresponding to n-butyl methacrylate is in the range from 4:1 to 1.5:1.

12. The hydraulic fluid of claim 4, wherein the comb polymer comprises at most 0.5% by weight of repeat units corresponding to at least one dispersing monomer.

13. The hydraulic fluid of claim 4, wherein the comb polymer has a limiting viscosity in the range from 50 to 70 ml/g.

14. The hydraulic fluid of claim 4, wherein the hydraulic fluid has a viscosity measured to ASTM D 445 at 40° C. in the range from 10 to 120 mm²/s.

15. The hydraulic fluid of claim 4, wherein the hydraulic fluid further comprises at least one defoamer which is a copolymer comprising at least one polyalkyl (meth)acrylate and at least one unit corresponding to at least one alkoxylated (meth)acrylate.

16. A method for improving the energy efficiency of a hydraulic system, comprising operating the hydraulic system with the hydraulic fluid of claim 4.

17. A method for improving the load-bearing capacity of a hydraulic system, comprising operating the hydraulic system with the hydraulic fluid of claim 4.

18. The hydraulic fluid of claim 5, wherein the hydraulic fluid comprises 1 to 30% by weight of the comb polymer.

19. The hydraulic fluid of claim 7, wherein the comb polymer comprises 20 to 60% by weight of the at least one repeat unit corresponding to the at least one macromonomer with a molecular weight of at least 500 g/mol.

20. A composition, comprising the comb polymer of claim 1 and at least one hydraulic fluid.
